(19) United States
(12) Patent Application Publication
(10) Pub. No.: US 2009/0246240 A1
(43) Pub. Date: Oct. 1, 2009

(54) DRY BACTERICIDAL NONWOVEN WIPE

(76) Inventor: Ronald A. Holmberg, Fairfield, CT (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/054,764

(22) Filed: Mar. 25, 2008

(51) Int. Cl. A01N 25/08; A01N 25/34; A01N 33/12; A01P 1/00

(52) U.S. Cl. 424/409; 514/643

(57) ABSTRACT

A dry bactericidal wipe that provides a greater than 99% reduction in bacterium including methicillin resistant Staphylococcus aureus (MRSA), Staphylococcus aureus, and Klebsiella pneumoniae. The dry bactericidal wipe comprises a nonwoven formed primarily of hydrophilic fibers and a binder distributed throughout the hydrophilic fibers in an amount effective to maintain the structural integrity of the nonwoven. The binder containing a bactericidal agent is absorbed into the fibers of the wipe where it is immediately effective against methicillin Resistant Staphylococcus aureus (MRSA), Staphylococcus aureus, and Klebsiella pneumoniae. The bactericidal dry wipe is packaged, stored, shipped, sold, and used in a dry condition

### FIELD OF INVENTION

The invention is directed to a bactericidal nonwoven wipe which may be packaged shipped, and used in a dry condition.

### BACKGROUND

Eliminating microorganisms on human and animal tissue and hard surfaces has grown in importance. Antimicrobials capable of destroying or inhibiting growth of microorganisms or bacteria have been used in conjunction with delivery articles, such as textiles, both woven, knit, and nonwovens, as well as other substrates as one approach to combat this aspect of modern life. Aqueous compositions including various antimicrobials have been applied to nonwovens for skin cleansings applications and care. Hard surface wipes have developed in a similar manner. Most compositions containing ingredients similar to those used in skin cleansing articles along with solvents, glycols, or other aqueous compositions have been combined with a delivery article such as nonwovens. Most known attempts remain moist from manufacture and packaging through use and disposal. Some few attempts are anhydrous at the time of packaging and shipment, but require the introduction of moisture at the point of use to activate the composition and trigger beneficial antimicrobial activity. Further, the incorporation of an antimicrobial composition into a textile substrate has generally occurred during processing at times separate and different from the formation of the delivery article itself.

### SUMMARY OF THE PRESENT INVENTION

One aspect of the present invention, however, is recognition of the need for a dry, bactericidal, non-woven fabric wipe that is initially dry and remains substantially dry during storage, packaging, and use and also effectively eliminates bacteria. As used in this application, the term “bactericidal” is meant to reduce (kill) at least 90% of the methicillin resistant Staphylococcus aureus (MRSA), Staphyloccus aureus, or Klebsiella pneumoniae strains of bacteria from a surface. Such wipes are well suited to more effectively remove bacteria for applications such as hard surface cleaning, medical cleaning, electrical products such as computer keyboards and/or a situation in which the wiping surface is sensitive to moisture. Such a wipe would also eliminate the need for moisture control packaging during distribution of a wipe to an end-user.

Accordingly, the wipe of the present invention is a non-woven substrate formed primarily of hydrophilic fibers (those that have an affinity for or absorb water or moisture) such as cotton or rayon or other cellulosic fibers such as lyocell. The non-woven substrate includes an adhesive binder which maintains the structural integrity of the non-woven fabric. The bactericidal agent is absorbed in and carried by the hydrophilic fibers, which have initially received the antimicrobial agent along with the binder. The result is a dry wipe that can be packaged, shipped, and used in dry form and needs no solvents, glycols, water, or catalysts to activate the bactericide.

In a preferred form the wipe contains greater than 50% hydrophilic fibers and the bactericidal agent is tetradecyldimethylbenzyl ammonium chloride, a bactericide which is effective to kill more than 99% of bacteria such as methicillin resistant Staphylococcus aureus (MRSA), Staphylococcus aureus, and Klebsiella pneumoniae.

Another aspect of the invention is the method by which the dry wipe is produced. A fibrous web of primarily hydrophilic fibers such as cotton, rayon, or lyocelle is formed. The bactericidal agent is mixed into the adhesive binder, and then the binder/bactericide is applied to the non-woven substrate. The substrate is then heated to drive off water from the binder/bactericide solution, leaving a dry wipe in which the bactericidal agent has been absorbed and has become an integral part of the non-woven fibrous wipe.

Still another aspect of the invention is the bactericidal agent itself. Tetradecyldimethylbenzyl ammonium chloride is part of the family of quaternary ammonium chlorides, most of which have some antimicrobial effect. This particular quaternary ammonium chloride has been found, to have extremely high bactericidal effect on three extremely difficult bacteria to kill, namely methicillin resistant Staphylococcus aureus (MRSA), Staphylococcus aureus, and Klebsiella pneumoniae. This bactericide has utility in dry and wet wipes, in non-woven fabrics used to make hospital gowns and masks, and as a disinfecting solution itself which can be sprayed or wiped into contaminated surfaces.

Yet another aspect of the invention is a method for producing bactericidal hydrophilic fibers, such as cotton and rayon. Baled fibers are opened and processed as fibers, not an engineered fabric. The fibers are saturated in a solution of bactericidal agent and water. They are then dried and rebated for use in a further textile process such as spinning for eventual woven or knit fabric production or for non-woven production. Because of the natural absorbency of the aqueous bactericide containing solution into the fiber, after drying the whole fiber cross-section would contain the bactericide that has been absorbed. The fibers could be rebated and sold for various uses.

### BRIEF DESCRIPTION OF DRAWING

FIG. 1 is a schematic block diagram illustrating a process for forming the dry bactericidal wipe of the present invention.

### DESCRIPTION

Certain exemplary embodiments of the present invention are described below and illustrated in the accompanying drawing. The specific embodiments described are for purposes of illustrating embodiments of the present invention and should not be interpreted as limiting the scope of the invention. Other embodiments of the invention, and certain modifications and improvements of the described embodiments, will occur to those of skill in the art, and all such alternate embodiments, modifications and improvements are within the scope of the present invention.

The nonwoven wipe is formed, at least primarily, from hydrophilic fibers dry laid into a matrix, which has added to it a binder and a bactericidal agent, thus providing a bactericidal dry wipe which will, upon heating and drying, be immediately effective against certain hard to control bacteria. The dry-laid process may be of the type in which fibers are carded and cross lapped, garneted and cross-lapped, or air-laid, or other known dry-laid process. A conventional binder joins a plurality of fibers together to impart an effective amount of strength and durability. The bactericidal agent initially mixed with binder is absorbed into and deposited on the surface of the hydrophilic fibers of the nonwoven matrix to provide a dry bactericidal nonwoven wipe 10. When certain bactericides are used, there results a greater than 98% reduction in bacterium including methicillin resistant Staphylococcus aureus (MRSA), Staphylococcus aureus, and Klebsiella pneumoniae. Thus, the dry antimicrobial nonwoven wipe 10 will destroy bacterium such as methicillin resistant Staphylococcus aureus (MRSA), Staphylococcus aureus, and Klebsiella pneumoniae without the need for a catalyst, solvent, glycol, water or other activating methods. The term “dry wipe” when used in conjunction with “wipe” or refers to a material that is substantially free of moisture except that which is naturally present when exposed to ambient conditions. The dry antimicrobial nonwoven wipe of the invention will have a moisture content less than about 20%, more preferably less than about 15%, and most preferably less than about 12%.

Hydrophilic fibers are the principal fibers that make up the batt or matrix of the dry bactericidal nonwoven wipe. The propensity of hydrophilic fibers to absorb water permits the incorporation of a composition containing a bactericidal agent into the fiber structure. Hydrophilic fibers such as cotton and other natural fibers, rayon, lyocell or the like can be used singularly, in combination with each other or in combination with a minor quantity of polymeric (non-hydrophilic or hydrophobic) fibers. The inventers contemplate the use of staple fibers having a discrete length ranging from about 20 mm up to about 100 mm. Fiber denier can be less than about 30 denier, more preferably less than about 15 denier, most preferably less than 3 denier. Synthetics fibers having hydrophilic properties, such as rayon and lyocell, are available in a variety of cross-sectional shapes such as circular, tri-lobal, triangular or ribbon.

Thermoplastic fibers are generally non-absorbent (hydrophobic), but should be a minor component of the wipe. Fibers such as polyethylene terephthalate, polypropylene, polyamide 6, polyamide 6,6, polylactic acid are in this category. Co-polymers of polyethylene terephthalate, polypropylene, polyamide 6, polyamide 6,6, polylactic acid can also be used. Thermoplastic fibers can be bi-component fibers having configurations such as side-by side, sheath-core, trilobal-tipped and islands in the sea and any combination thereof. Thermoplastic fibers may be present at level up to about 50% by weight of the wipe, however the primary component should be the hydrophilic fibers. Other fibers that are generally non-absorbent, but may be used as minor components, include such mineral fibers as quartz, glass, silica, etc.

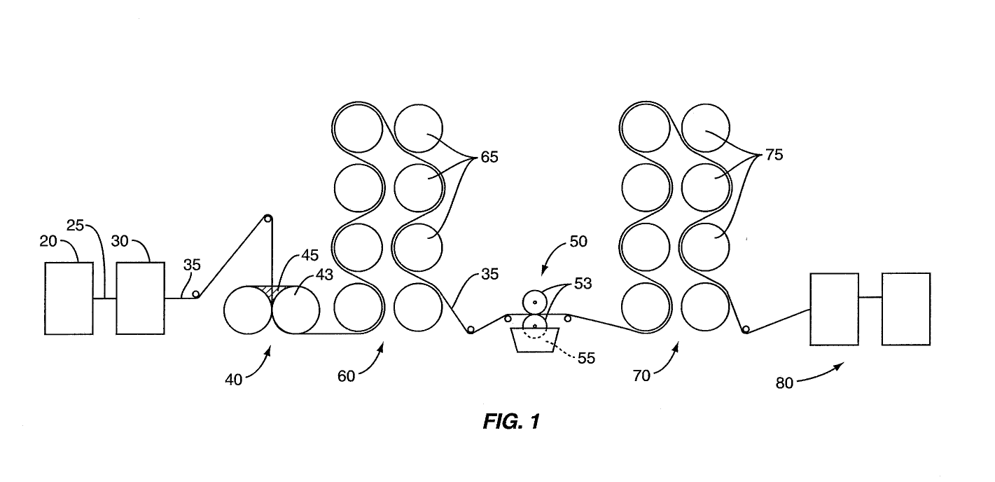

Referring to FIG. 1, the initial step in forming the wipe is fiber preparation. Fiber preparation transforms bales 20 of densely packaged fibers into tufts of fibers suitable for web formation. The tufts of fibers are carried along belt 25 to the web formation station 30. Fiber preparation involves conventional steps, such as bale opening, blending, coarse and fine opening and feed preparation. Bale opening and blending mix different fiber types, fiber deniers, fiber cross-sections, or similar fibers from different bales. For example, rayon fibers can be mixed with polyester fibers; rayon fibers having a denier differential can be mixed; or rayon fibers from one or more bales of rayon fibers can be mixed. Owing to the propensity of hydrophilic fibers to absorb water, a typical wipe would be formed of 100% hydrophilic fibers, such as rayon. However, the wipe could also be a blend of 50-100% hydrophilic fibers and up to 50% thermoplastic fibers.

Web formation results in a fibrous web that is carried on a belt 35. The term “fibrous web” refers to an assembly of oriented fibers. For example, web formation can orient fibers predominately in one direction, or can orient fibers in more than one direction. Typically following fiber preparation, the web formation station will include either a carding machine or a garnet, along with a cross-lapper. Alternatively the web formation could be by an air-lay machine or other known dry laid processor. The carding machine or garnet at web formation station 30 will align fibers predominately in the machine direction creating a fibrous web 35 on belt 25 with anisotropic properties. A cross-lapper is often used with a card or garnet to re-orient the fibers into a more uniform fiber orientation and increase the basis weight of the resulting fibrous web. An air-lay machine, on the other hand, will transform tufts of fibers from fiber separation station 20 into fibrous web at the web formation station having fibers oriented in more than one direction.

Having arranged fibers into a fibrous web with a desired fiber orientation and basis weight on belt 35, adhesive binder composition is applied at binder application stations 40 and 50. Binder application refers to the point during the formation of a nonwoven that the binder composition is applied through saturation, impregnation, spraying, foam application, padding, coating, dipping or print bonding. In the illustrated embodiment application of binder occurs at more than one application station. For example, a first composition 45 can be applied from a first apparatus 43 and a second from a second apparatus 53. Binder compositions may also differ in their make-up. While a two step binder application process is shown and described, it could occur in one step, or in more than two.

In the embodiment described at station 43 the binder composition 45 is foam applied resulting in an add-on of 10.6 g of binder applied per square yard of nonwoven. At station 53 1.2 grams of binder/bactericidal composition 55 per square yard of nonwoven is pad applied resulting in an add-on of 0.8 grams of binder and 0.4 grams of bactericidal agent per square yard of nonwoven. Stations 43 and 53 added therefore apply about 11.4 grams of binder per square yard of fibrous web and about 0.4 grams of bactericidal agent. Expressed as a percent, the fibers make up about 69% of the nonwoven by weight, the binder comprises about 30% of the nonwoven by weight, the bactericidal agent comprises 1% of the nonwoven by weight. As a result, each square yard of nonwoven will then contain approximately 35.5 grams of fiber in addition to the binder and bactericidal agent. The amounts of binder and agent applied per square yard are for illustrative purposes only. Obviously these ratios or percentages can vary considerably.

While the process described above utilizes antimicrobial agent only in composition 55, it could theoretically also be included additionally in composition 45, however application in composition 55 only is preferred. It should be recognized that, while any number of binder application/drying stations may be used, the bactericide should be applied in the last stage to prevent masking by the binder.

The purpose of the binder is to impart strength to the wipe by joining or bonding the fibers together. The amount of binder should be effective to bind a plurality of fibers so that the resultant dry antimicrobial nonwoven wipe will have sufficient strength and dimensional stability to withstand the rigors of use by an end user. A typical binder would be a latex binder comprising at least one polymer selected from the group coacrylic, styrenated acrylic, vinyl acetate, vinyl acrylic, ethylene vinyl acetate, styrene-butadiene, polyvinyl chloride and ethylene/vinyl chloride.

The preferable bactericidal agent used in the present invention is a quaternary ammonium compound. Quaternary ammonium compounds include at least one higher molecular weight group and at least one lower molecular weight group linked to a common, positively charged nitrogen atom. One or more higher molecular weight groups include, but are not limited to, higher alkyl groups containing about 6-30 carbon atoms that are branched, unbranched, saturated, or unsaturated. One or more lower molecular weight groups include, but are not limited to, 1-12 carbon atoms that are branched, unbranched, saturated, or unsaturated. Specific lower molecular weight substituents include, but are not limited to, alkyls of 1 to 4 carbon atoms, such as methyl or ethyl, alkyl ethers, hydroxyalkyls, or benzyl groups. One or more of the higher or lower molecular weight substituents can include, or can be replaced by, an aryl moiety. An electrically balancing anion (counterion) can be linked to the positively charged nitrogen atom. Such anions include, but are not limited to, halides, acetates, nitrates, or lower alkosulfates. Specific anions include, but are not limited to, bromide, sulfate, iodide, alkycarboxylate, methosulfate, ethosulfate, phosphate, carboxylic acid, or chloride.

Specific quaternary ammonium compounds that possibly could be used in the antibacterial composition include, but are not limited to, alkyl ammonium halides such as lauryl trimethyl ammonium chloride and dilauryl dimethyl ammonium chloride; alkyl aryl ammonium halides such as octadecyl dimethyl benzyl ammonium bromide; ethyl dimethyl stearyl ammonium chloride, trimethyl stearyl ammonium chloride, trimethyl cetyl ammonium chloride, dimethyl ethyl lauryl ammonium chloride, dimethyl propyl myristyl ammonium chloride, dinonyl dimethyl ammonium chloride, didecyl dimethyl ammonium chloride, diundecyl dimethyl ammonium chloride, didecyl dimethyl ammonium chloride, dinonyl)-ethyl ammonium chloride, dimethyl ethyl benzyl ammonium chloride, 3-(trimethyxyosilyl)propyldidecylmethyl ammonium chloride, 3-(trimethoxysilyl)propyloctadecycdimethyl ammonium chloride, dimethyl dioctyl ammonium chloride, didecyl dimethyl ammonium chloride, didodecyl dimethyl ammonium chloride, dimethyl ditetradecyl ammonium chloride, dihekadecyl dimethyl ammonium chloride, dimethyl dioctadecyl ammonium chloride, decyl dimethyl octyl ammonium chloride, dimethyl dodecyloctyl ammonium chloride, benzyl decyl dimethyl ammonium chloride, benzyl dimethyl dodecyl ammonium chloride, tetradecyl benzyl dimethyl ammonium chloride, decyl dimethyl(ethyl benzyl)ammonium chloride, decyl dimethyl(dimethyl benzyl)-ammonium chloride, (chlorobenzyl)-decyl dimethyl ammonium chloride, decyl-(dichlorobenzyl)-dimethyl ammonium chloride, benzyl didecyl methyl ammonium chloride, benzyl didocyl methyl ammonium chloride, benzyl ditetradecyl methyl ammonium chloride, benzyl dodecyl ethyl methyl ammonium chloride, and the like. While all of the quaternary ammonium compounds in the list above are known to have bactericidal effect against some bacteria, they have not been tested for effectiveness against the three strains discussed.

The bactericidal agent preferred for use in the current invention is tetradecyl benzyl dimethyl ammonium chloride. The inventors have found that this agent has and provides a greater than 90%, preferably greater than 95%, and more preferably greater than 99% reduction in bacterium, including methicillin resistant Staphylococcus aureus (MRSA), Staphylococcus aureus, Klebsiella pneumoniae, or combinations thereof.

In the bonding process shown in FIG. 1, binder compositions 45 and 55 are introduced to fibrous web 35. Foam application is one approach, however the inventors contemplate that the application could also be saturation, impregnation, spraying, padding, coating, dipping or print bonding. Foam application directs a fibrous web 35 into a station 43 where the composition 45 is delivered continuously or in discrete amounts from an external source.

Following a first application step fibrous web 35, with some of composition 45, passes through heating stage 60. Heat from heated rolls 65 removes moisture and water from composition 45, and cures, crosslinks or fixates the binder onto fibrous web 35. Heat application stage 60 includes a series of stacked heating cans 65 around which fibrous web 35 will travel. Heated cans 52 are heated by oil or steam. Temperature of heated cans 65, dwell time of fibrous web 35 in heating stage 60, basis weight of fibrous web 35, the take-up of the composition 45 in application stage 40 and the make-up of the binder composition impact the amount of moisture removal and the level of cure or crosslinking. Heated cans 65 are preferably operated at a temperature between about 150° F. and about 350° F., more preferably between about 200° F. and about 300° F. and most preferably between about 225° F. and about 275° F. The preferred temperatures are applied to fibrous web 35 for less than about 75 seconds, more preferably less than about 65 seconds, most preferably less than about 50 seconds. Heating step 50 can include through air heating, infrared heating or similar mechanism where thermal energy is imparted onto and through the fibrous web 35.

As discussed above, fibrous web 35 then enters second application step 50, passing through second station 53 where the second binder/bactericidal composition 55 is introduced, preferably by padding. Here the binder/bactericidal composition 55 will be absorbed into the fibers and fill the voids of the fibrous web 35. Application step 50 is preferably a padding operation, but could also be impregnation, spraying, foam application, coating, dipping or print bonding. At application step 50 the bactericidal agent is absorbed within and deposited onto the surface of the fiber, and the binder is deposited within the voids of fibrous web 35. Most of the bactericidal agent will be absorbed into the fibers, while a binder and some antimicrobial agent remains on the surface of the fibers and within voids of fibrous web 35. The inventors contemplate that the amount, or presence, of a binder or bactericidal agent may be adjusted to control the amount that is absorbed into the fiber.

A second heating stage 70 is located downstream of the second application step. Heated cans 75 are operated at a temperature between about 150° F. and about 350° F., more preferably between about 200° F. and about 300° F. and most preferably between about 225° F. and about 275° F. Such temperatures are applied to fibrous web 35 for less than about 75 seconds, more preferably less than about 65 seconds, most preferably less than about 50 seconds. Heating step 70 occurs through air heating, infrared heating or similar mechanism where thermal energy is imparted onto and through the fibrous web 35.

A slitting step 80 occurs after the first 60 or second 70 heat application step as the process has been selected. Typically slitting step 80 includes slitting and rolling the completed web 35 to the proper size in roll form for subsequent converting and fabrication into cloths for distribution to the user.

### EXAMPLE

A dry bactericidal wipe comprising was formed using 100% 1.5 denier Visocel® rayon fibers 38-mm in length, available from SNIACE of Torrelavega, Cantabria, Spain. A binder composition containing 5% of an acrylic binder, ST 954, available from Rohm and Hass Chemicals LLC of Charlotte, N.C., U.S.A. and 95% water was applied first using foam application at the first application at a level of about 10.6 grams per square yard, heating using steam or oil heated cans for about 45 seconds at a temperature of about 275° Fahrenheit. A second application of the binder/bactericidal composition containing 5% of the ST 954 acrylic binder, 1% tetradecylbenzyldimethyl ammonium chloride, and 94% water was applied by padding at a level of about 1.2 grams per square yard. The web is then heated in the same manner as above. The wipe has thickness of about 11 mils measured according to ASTM D 1777 and a basis weight of 37.8 g/yd², measured according to ASTM D 3776. A sample was prepared for bactericidal testing according to AATCC Test Method 100: Assessment of Antibacterial Finishes on Textile Materials. The dry bactericidal wipe resulted in a 99.21% reduction in methicillin resistant Staphylococcus aureus (MRSA), a 99.87% reduction in Staphylococcus aureus bacterium, and a 99.3% reduction in the Klebsiella pneumoniae bacterium.

Another aspect of the invention involves the production of antimicrobial, preferably bactericidal, hydrophilic natural or cellulosic fibers that can be used in the formation of non-woven fabrics, formed into yarn, and woven or knit into fabrics for various uses. Hospital gowns, face masks, barriers, and bed liners other applications for antimicrobial fibers. Antimicrobial fibers are derived from natural or other absorbent fibers. Beginning with opening, fibers can be opened from a bale. Opening transforms a bale form a tightly packaged mass of fiber into tufts of fibers. The fibers, upon opening, are spread about to form a fibrous mat having minimal fiber cohesion. An antimicrobial composition is introduced to the opened fibers using appropriate saturation techniques. The antimicrobial composition contains an antimicrobial or bactericidal agent discussed depending on the intended use and application. As the antimicrobial composition is applied to the fibers, the antimicrobial agents are absorbed into the fibers themselves. The fibers can be exposed to heat removing substantially all moisture except that which is naturally present in the fibers at ambient conditions. Heat lamps, through-air ovens, or infrared heat can be a few methods used to drive off any remaining non-ambient moisture. The fibers can then be packaged in a bale for later processing and used to form fibers for nonwovens, yarn, or woven or knitted fabrics in appropriate processes.

Another aspect of the present invention is the discovery of a new use for a certain bactericidal agent, namely the tetradecylbenzyldimethyl ammonium chloride. As will be appreciated by those skilled in the art, there are various methods to assess the effectiveness of a bactericidal agent. The discovery here is that this particular bactericidal agent provides a greater than 90%, preferably greater than 95%, and more preferably greater than 99% reduction in bacterium, including methicillin resistant Staphylococcus aureus (MRSA or Mursa), Staphylococcus aureus, Klebsiella pneumoniae, or combinations thereof. One method for determining the reduction of such organisms is American Association of Textile Chemists and Colorists (AATCC) Test Method 100, using American Type Culture Collection (ATCC) reference organisms ATCC 33591, methicillin resistant Staphylococcus aureus (MRSA), ATCC 6538, Staphylococcus aureus, and ATCC 4352, Klebsiela pneumoniae. It is contemplated this particular bactericidal agent can be used in sprays and other composition, as a topical treatment, and as an additive in polymeric resins to be molded into products having bactericidal capabilities, as well as into wipes.

The invention has been described herein in terms of several embodiments and constructions that are considered by the inventors to represent the best mode of carrying out the invention. It will be understood by those skilled in the art that various modifications, variations, changes and additions can be made to the illustrated embodiments without departing from the spirit and scope of the invention. These and other modifications are possible and within the scope of the invention as set forth in the claims.

We claim:

1. An antimicrobial dry wipe comprising:
(a) a nonwoven fabric formed primarily of hydrophilic staple fibers;
(b) a binder distributed throughout the hydrophilic fibers in an amount effective to maintain the structural integrity of the nonwoven;
(c) bactericidal agent absorbed into the hydrophilic fibers, and immediately effective, thereby requiring no glycols, no solvents and no catalysts to activate the antimicrobial agent; and
(d) the dry non-woven fabric wipe packaged, stored, shipped, sold, and used in a dry condition.

2. The dry wipe as in claim 2 wherein the staple fibers are selected from the hydrophilic group consisting of rayon, lyocell, cotton, and combination thereof.

3. The dry wipe as in claim 2 and further including less than 50% by weight hydrophobic fibers selected from the group consisting of thermoplastic staple fibers and mineral fibers.

4. The dry wipe as in claim 1, wherein the binder is selected from the group of latexes consisting of acrylic, styrenated acrylic, vinyl acetate, vinyl acrylic, ethylene vinyl acetate, styrene-butadiene, polyvinyl chloride and ethylene/vinyl chloride.

5. The dry wipe as in claim 1, wherein the bactericidal agent is a quaternary ammonium compound.

6. The dry wipe in claim 5, wherein the bactericidal agent is tetradecyldimethylbenzyl ammonium chloride.

7. The dry wipe as in claim 1, being a single use wipe.

8. A method of forming a dry wipe, comprising:
(a) providing hydrophilic fibers;
(b) forming a fibrous web from the hydrophilic fibers;
(c) applying a composition to the fibrous web, the composition comprising an adhesive binder and a bactericidal agent, whereby the binder bonds the fibers of the fibrous web and the bactericidal agent is absorbed into and retained within the hydrophilic fibers;
(d) applying heat to the fibrous web and the composition to form a dry bactericidal nonwoven fabric; and
(e) cutting the dry antimicrobial nonwoven to size for use as a wipe.

9. The method of claim 8, wherein the fibrous web is dry-laid.

10. The method of claim 8, wherein the fibrous web comprises at least 50% by weight of hydrophilic fibers.

11. The method of claim 8, wherein the hydrophilic fibers are selected from the group consisting of rayon, lyocell, and cotton.

12. The method of claim 8, wherein the fibrous web further comprises a minor quantity of hydrophobic fibers selected from the group consisting of thermoplastic fibers and mineral fibers.

13. The method of claim 8, wherein the binder is selected from the group consisting of acrylic, styrenated acrylic, vinyl acetate, vinyl acrylic, ethylene vinyl acetate, styrene-butadiene, polyvinyl chloride and ethylene/vinyl chloride.

14. The method of claim 8, wherein the composition contains at least 0.01% by weight of the composition of a bactericidal agent.

15. The method of claim 10, wherein the bactericidal agent is a quaternary ammonium compound.

16. The method of claim 15, wherein the bactericidal agent is tetradecyldimethylbenzyl ammonium chloride.

17. The method of claim 8 wherein the binder/bactericidal agent ratio is in the range of 5:1 to 1:1.
